(19) United States
(12) Patent Application Publication
(10) Pub. No.: US 2025/0326171 A1
(43) Pub. Date: Oct. 23, 2025

(54) Injection Molding Machine, Injection Apparatus, Clamping Apparatus, and Method of Data Processing

(71) Applicant: THE JAPAN STEEL WORKS, LTD., Tokyo (JP)

(72) Inventor: Motomu FURUMOTO, Tokyo (JP)

(21) Appl. No.: 19/077,408

(22) Filed: Mar. 12, 2025

(30) Foreign Application Priority Data
Apr. 23, 2024 (JP) 2024-069881

(51) Int. Cl. B29C 45/76; B29C 45/64

(52) U.S. Cl. CPC B29C 45/7653; B29C 45/64; B29C 2045/645; B29C 2045/7606; B29C 2945/7618; B29C 2945/76224; B29C 2945/76658; B29C 2945/76702

(57) ABSTRACT

An injection molding machine includes an injection apparatus that injects an injection material into a mold and a clamping apparatus that clamps the mold. An injection control device that controls injection of the injection material by the injection apparatus is connected to a clamping control device to communicate data therewith, the clamping control device controlling a magnet clamp of the clamping apparatus.

### CROSS REFERENCE TO RELATED APPLICATIONS

This nonprovisional application is based on Japanese Patent Application No. 2024-069881 filed with the Japan Patent Office on Apr. 23, 2024, the entire contents of which are hereby incorporated by reference.

### BACKGROUND OF THE INVENTION

### Field of the Invention

The present disclosure relates to an injection molding machine, an injection apparatus, a clamping apparatus, and a method of data processing.

### Description of the Background Art

An injection molding machine that manufactures a molded article by injecting an injection material into a mold has been known. For example, Japanese Patent Laying-Open No. 2023-155538 discloses an injection molding machine including a clamping apparatus that clamps a mold and an injection apparatus that injects an injection material into the mold attached to the clamping apparatus.

### SUMMARY OF THE INVENTION

A clamping apparatus of an injection molding machine includes a control device that controls a magnet clamp to and from which a mold is attachable and removable. In an injection apparatus of the injection molding machine, injection of an injection material into the mold is controlled by a control device different from the control device dedicated for the magnet clamp. The injection molding machine is thus configured to manufacture a molded article under the control by two control devices that control the injection apparatus and the clamping apparatus, respectively.

In trial run of the injection molding machine before shipment of the injection molding machine from a factory or servicing after delivery of the injection molding machine to a client, a user should use a user device to set data for initial setting or the like in each of the two control devices described above. In this case, the user should individually connect the user device to each of the control device on a side of the injection apparatus and the control device on a side of the clamping apparatus and hence work efficiency was poor.

The present disclosure was made to solve such a problem, and an object thereof is to provide a technique to easily enable data communication with each of a control device on a side of an injection apparatus and a control device on a side of a clamping apparatus.

An injection molding machine according to one embodiment includes an injection apparatus that injects an injection material into a mold and a clamping apparatus that clamps the mold. An injection control device that controls injection of the injection material by the injection apparatus is connected to a clamping control device to communicate data therewith, the clamping control device controlling a magnet clamp of the clamping apparatus.

An injection apparatus according to one embodiment includes an injection control device that controls injection of an injection material, the injection control device being connected to a clamping control device to communicate data therewith, the clamping control device controlling a magnet clamp of a clamping apparatus.

A clamping apparatus according to one embodiment includes a clamping control device that controls a magnet clamp, the clamping control device being connected to an injection control device to communicate data therewith, the injection control device controlling injection of an injection material by an injection apparatus.

A method of data processing according to one embodiment includes obtaining injection control data for control of injection of an injection material from a user device, storing the injection control data, obtaining clamping control data for control of a magnet clamp from the user device, and outputting the clamping control data to a clamping control device that controls the magnet clamp.

The foregoing and other objects, features, aspects, and advantages of this invention will become more apparent from the following detailed description of this invention when taken in conjunction with the accompanying drawings.

### BRIEF DESCRIPTION OF THE DRAWINGS

FIG. 1 is a schematic diagram showing an injection molding system according to an embodiment.

FIG. 2 is a schematic diagram showing an injection molding system according to a comparative example.

FIG. 3 is a block diagram showing an internal configuration of each of an injection control device, a clamping control device, and a user device included in the injection molding system according to the embodiment.

FIG. 4 is a diagram showing an exemplary setting screen for setting a magnet clamp, which is shown on a display device of the user device according to the embodiment.

FIG. 5 is a diagram showing an exemplary setting screen for setting an injection apparatus, which is shown on the display device of the user device according to the embodiment.

FIG. 6 is a diagram showing an exemplary check screen for checking a state of the magnet clamp, which is shown on the display device of the user device according to the embodiment.

FIG. 7 is a diagram showing an exemplary range of an address shared between the injection control device and the clamping control device according to the embodiment.

FIG. 8 is a diagram showing contents of coil data shared between the injection control device and the clamping control device according to the embodiment.

FIG. 9 is a diagram showing contents of input status data shared between the injection control device and the clamping control device according to the embodiment.

FIG. 10 is a diagram showing contents of input register data shared between the injection control device and the clamping control device according to the embodiment.

FIG. 11 is a diagram showing contents of holding register data shared between the injection control device and the clamping control device according to the embodiment.

FIG. 12 is a flowchart showing exemplary processing relating to injection control data and clamping control data, which is performed by an injection molding machine according to the embodiment.

FIG. 13 is a flowchart showing exemplary processing relating to state data, which is performed by the injection molding machine according to the embodiment.

### DESCRIPTION OF THE PREFERRED EMBODIMENTS

An embodiment of the present disclosure will be described in detail below with reference to the drawings. The same or corresponding elements in the drawings have the same reference characters allotted and description thereof will not be repeated.

### Main Configuration of Injection Molding System

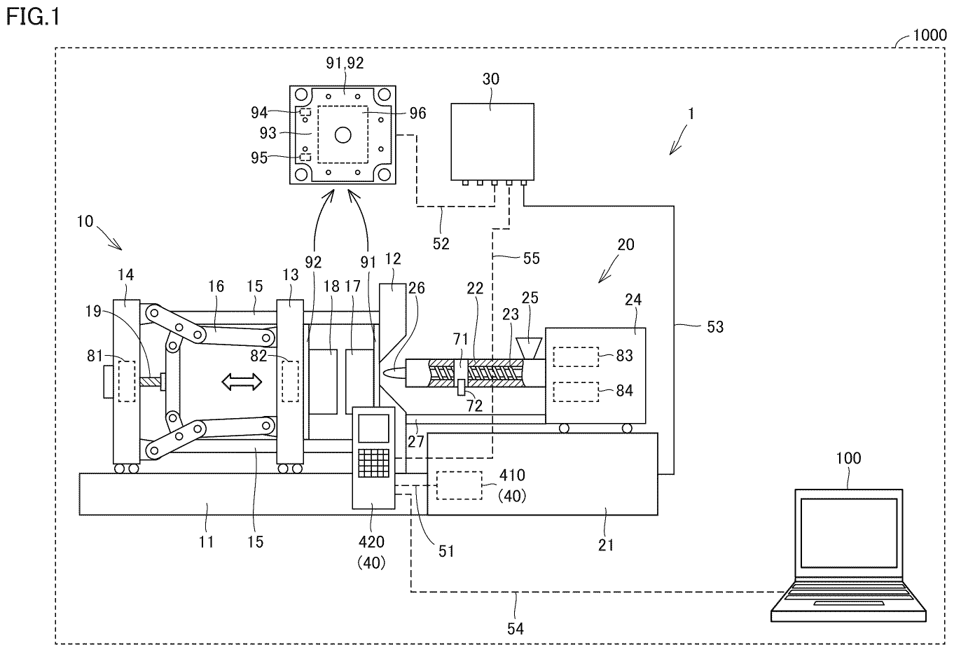

A configuration of an injection molding system 1000 according to an embodiment will be described with reference to FIG. 1. FIG. 1 is a schematic diagram showing injection molding system 1000 according to the embodiment. As shown in FIG. 1, injection molding system 1000 includes an injection molding machine 1 and a user device 100.

Injection molding machine 1 includes a clamping apparatus 10 that clamps molds 17 and 18 and an injection apparatus 20 that injects an injection material into the molds. Injection molding machine 1 is configured to manufacture a molded article by injection of the injection material from injection apparatus 20 into molds 17 and 18 attached to clamping apparatus 10. The injection material includes, for example, a plastic material referred to as a pellet.

An injection molding process for manufacturing a molded article with injection molding machine 1 includes a mold closing step, an injection step, a pressure holding step, a mold opening step, a plasticization step, and an ejection step. Injection molding machine 1 can manufacture one molded article by performing the injection molding process including these steps once and can manufacture a plurality of molded articles by repeatedly performing the injection molding process. Injection molding machine 1 can manufacture molded articles various in shape and material and performs the injection molding process different depending on a shape of a molded article and a type of a material.

Clamping apparatus 10 includes a bed 11, a fixed platen 12, a movable platen 13, a clamping housing 14, a tie bar 15, a clamping mechanism 16, molds 17 and 18, a ball screw 19, a clamping control device 30, servo motors 81 and 82, magnet clamps 91 and 92, a temperature sensor 94, and a magnetic field sensor 95.

Fixed platen 12, clamping housing 14, and movable platen 13 are arranged on bed 11. Each of clamping housing 14 and movable platen 13 is configured as being slidable in a certain direction (for example, a direction in parallel to an arrangement surface of bed 11) over bed 11. Tie bar 15 is arranged between fixed platen 12 and clamping housing 14 to couple fixed platen 12 and clamping housing 14 to each other.

Tie bar 15 arranged between fixed platen 12 and clamping housing 14 to couple fixed platen 12 and clamping housing 14 to each other passes through movable platen 13. Movable platen 13 is configured as being slidable in a certain direction (for example, the direction in parallel to the arrangement surface of bed 11) over bed 11 between fixed platen 12 and clamping housing 14.

Clamping mechanism 16 is arranged between clamping housing 14 and movable platen 13 and includes a toggle mechanism. Clamping mechanism 16 uses the toggle mechanism to bring movable platen 13 closer to clamping housing 14 fixed on bed 11 or to move movable platen 13 away from clamping housing 14.

Magnet clamp 91 is attached as being fixed to fixed platen 12. Magnet clamp 92 is attached as being fixed to movable platen 13. Magnet clamps 91 and 92 each include a magnet clamp plate 93 in a form of a flat plate. A surface of magnet clamp plate 93 of magnet clamp 91 and a surface of magnet clamp plate 93 of magnet clamp 92 are opposed to each other. Mold 17 is removably attached to the surface of magnet clamp 91 opposed to magnet clamp 92. Mold 18 is removably attached to the surface of magnet clamp 92 opposed to magnet clamp 91.

A magnet core 96 including a permanent magnet, an electropermanent magnet, and a coil is provided in magnet clamp plate 93 of each of magnet clamps 91 and 92. Molds 17 and 18 can be attached to and removed from respective magnet clamps 91 and 92, depending on whether electric power is supplied from clamping control device 30 to magnet core 96.

Specifically, when a current is supplied from clamping control device 30 to magnet core 96, magnetic poles of the electropermanent magnet are reversed, magnetic lines of force of the permanent magnet and magnetic lines of force of the electropermanent magnet cancel each other, and no magnetic lines of force are generated from the surface of magnet clamp plate 93. Magnetizing force is thus not generated in magnet clamp plate 93 and molds 17 and 18 are removed from respective magnet clamps 91 and 92. Such a state of magnet clamps 91 and 92 from which molds 17 and 18 have been removed is also referred to as an “unclamped state.”

When a current is supplied from clamping control device 30 to magnet core 96 in the unclamped state, on the other hand, the magnetic poles of the electropermanent magnet return to the original state. In this case, magnetic lines of force of the permanent magnet and magnetic lines of force of the electropermanent magnet do not cancel each other, magnetic lines of force of the permanent magnet and magnetic lines of force of the electropermanent magnet are combined and strengthened, and magnetic lines of force are generated from the surface of magnet clamp plate 93. Strong magnetizing force is thus generated at magnet clamp plate 93 and molds 17 and 18 are attached to respective magnet clamps 91 and 92. Such a state of magnet clamps 91 and 92 to which molds 17 and 18 are attached is also referred to as a “clamped state.”

Temperature sensor 94 is provided in magnet clamp plate 93 and measures a temperature of magnet clamp plate 93. Temperature data indicating the temperature measured by temperature sensor 94 is transmitted to clamping control device 30. Magnetic field sensor 95 is provided in magnet clamp plate 93 and measures strength of magnetic field originating from magnetic lines of force generated from magnet clamp plate 93. Magnetic field data indicating strength of magnetic field measured by magnetic field sensor 95 is transmitted to clamping control device 30.

Servo motor 81 is provided in clamping housing 14. Servo motor 81 drives clamping mechanism 16 with ball screw 19 being interposed, under the control by clamping control device 30. Ball screw 19 converts rotational motion by servo motor 81 into linear motion and transmits linear motion to clamping mechanism 16 to drive clamping mechanism 16.

Mold 17 attached to fixed platen 12 and mold 18 attached to movable platen 13 are arranged as being opposed to each other between fixed platen 12 and movable platen 13. Mold 18 is moved toward or away from mold 17 by slide movement of movable platen 13 over bed 11 as clamping mechanism 16 is driven.

The mold closing step in the injection molding process thus includes a step of transition from a state in which molds 17 and 18 are distant from each other to a state in which they are in intimate contact with each other. The mold opening step in the injection molding process includes a step of transition from the state in which molds 17 and 18 are in intimate contact with each other to the state in which they are distant from each other.

Servo motor 82 is provided in movable platen 13. Servo motor 82 has a pin project in mold 18 or has the pin drawn from mold 18, under the control by clamping control device 30. With projection of the pin in mold 18, a molded article in intimate contact with mold 18 is removed.

The ejection step in the injection molding process thus includes a step of removing from mold 18, the molded article in intimate contact with mold 18.

Injection apparatus 20 includes a base 21, a cylinder 22, a screw 23, a drive apparatus 24, a hopper 25, an injection nozzle 26, a nozzle touch apparatus 27, an injection control device 40, a heater 71, a temperature sensor 72, and servo motors 83 and 84.

Drive apparatus 24 to which cylinder 22 has been attached is arranged on base 21. Servo motors 83 and 84 are provided inside drive apparatus 24. Screw 23 that mixes and kneads an injection material is provided inside cylinder 22.

Cylinder 22 is in a columnar shape provided with ends on a nozzle side and a hopper side. Servo motor 83 rotates screw 23 around an axis along a certain direction (for example, a direction in parallel to an arrangement surface of base 21) under the control by injection control device 40. Hopper 25 is provided at cylinder 22, and a particulate injection material yet to be plasticized is stored therein. As screw 23 is driven, the injection material stored in hopper 25 is charged into cylinder 22.

Heater 71 is a band heater that covers at least a part of cylinder 22. Heater 71 heats cylinder 22 under the control by injection control device 40. Temperature sensor 72 is implemented, for example, by a thermocouple, and measures a temperature of cylinder 22 heated by heater 71. Temperature data indicating the temperature measured by temperature sensor 72 is transmitted to injection control device 40. The injection material charged into screw 23 in cylinder 22 is mixed and kneaded by being turned in screw 23 as servo motor 83 is driven, while the injection material is heated by heat of cylinder 22 heated by heater 71.

The plasticization step in the injection molding process thus includes a step of mixing and kneading the injection material to be injected into molds 17 and 18 of clamping apparatus 10, by heating by cylinder 22 and rotation of screw 23.

Servo motor 84 drives screw 23 to slide toward molds 17 and 18 of clamping apparatus 10, under the control by injection control device 40. The injection material plasticized in screw 23 is thus conveyed to injection nozzle 26. Nozzle touch apparatus 27 slides injection apparatus 20 toward molds 17 and 18 of clamping apparatus 10 and brings injection nozzle 26 in contact with mold 17, under the control by injection control device 40. The injection material is thus injected into mold 18. Furthermore, a pressure is applied to the injected injection material and the injection material is held in molds 17 and 18.

The injection step in the injection molding process thus includes a step of injecting the injection material plasticized in the plasticization step into molds 17 and 18 of clamping apparatus 10. The pressure holding step in the injection molding process includes a step of applying a pressure to hold the injection material injected in the injection step in molds 17 and 18.

Injection control device 40 includes an interface unit 420 that performs a user interface function and a control unit 410 that controls injection of the injection material by injection apparatus 20. Control unit 410 is provided inside base 21 and connected to interface unit 420 through a communication cable 51 to communicate data therewith. Control unit 410 may be configured to communicate data with interface unit 420 through wireless connection such as Wi-Fi® or Bluetooth®, without being limited to wired connection. Control unit 410 may further be configured as being integrated with interface unit 420. Control unit 410 is connected to various components provided in injection apparatus 20, such as nozzle touch apparatus 27, heater 71, and servo motors 83 and 84, and controls injection of the injection material by injection apparatus 20 by controlling these components.

Clamping control device 30 is connected to magnet clamps 91 and 92 through a communication cable 52 to communicate data therewith. Clamping control device 30 may be configured to communicate data with magnet clamps 91 and 92 through wireless connection such as Wi-Fi® or Bluetooth®, without being limited to wired connection. Clamping control device 30 controls magnet clamps 91 and 92 to any state of the clamped state and the unclamped state by supplying the current to magnet clamps 91 and 92.

Clamping control device 30 is connected to injection control device 40 through a power supply cable 53 such that electric power is supplied from injection control device 40. Clamping control device 30 can control magnet clamps 91 and 92 with electric power supplied from injection control device 40 through power supply cable 53.

In injection molding machine 1, injection apparatus 20 and clamping apparatus 10 are interlocked with each other such that magnet clamps 91 and 92 do not operate while injection apparatus 20 is operating. For example, while injection apparatus 20 is injecting the injection material into molds 17 and 18 of clamping apparatus 10, electric power is not supplied from injection apparatus 20 to clamping control device 30. In this case, since the current is not supplied from clamping control device 30 to magnet clamps 91 and 92, magnet clamps 91 and 92 are maintained in the clamped state.

In injection molding machine 1 configured as described above, in trial run before shipment from a factory or servicing after delivery to a client, data for initial setting or the like should be set in each of injection control device 40 and clamping control device 30.

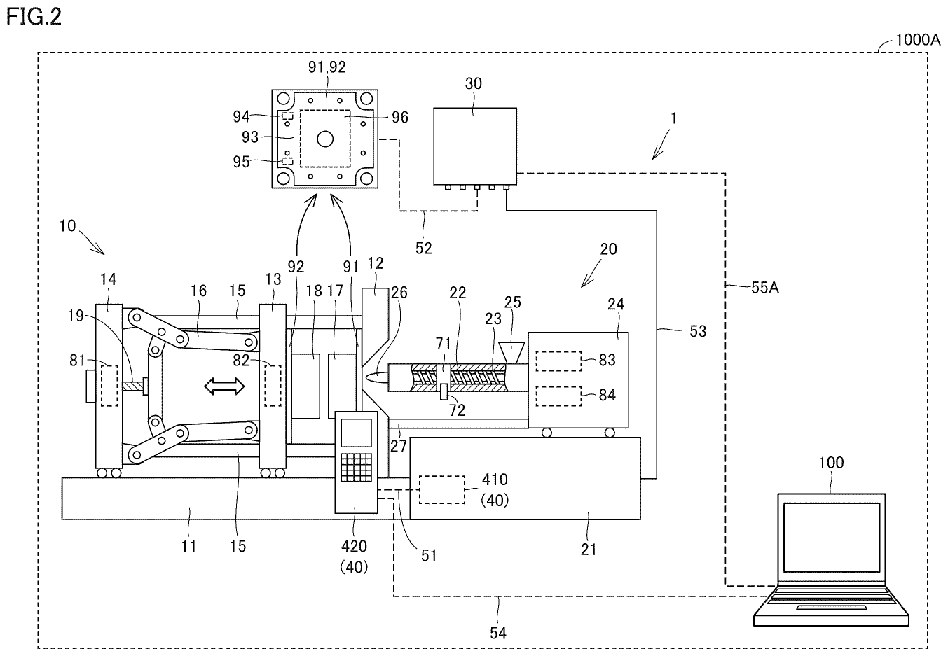

For example, FIG. 2 is a schematic diagram showing an injection molding system 1000A according to a comparative example. As shown in FIG. 2, injection control device 40 is connected to user device 100 through a communication cable 54 to communicate data therewith. Injection control device 40 may be configured to communicate data with user device 100 through wireless connection such as Wi-Fi® or Bluetooth®, without being limited to wired connection. A user can thus check, with user device 100, current data set in injection control device 40, by directly connecting user device 100 to injection control device 40. Furthermore, the user can transmit the data for initial setting for realizing control by injection control device 40 from user device 100 to injection control device 40 by inputting the data for initial setting to user device 100.

Clamping control device 30 is connected to user device 100 through a communication cable 55A to communicate data therewith. Clamping control device 30 may be configured to communicate data with user device 100 through wireless connection such as Wi-Fi® or Bluetooth®, without being limited to wired connection. The user can thus check, with user device 100, current data set in clamping control device 30, by directly connecting user device 100 to clamping control device 30. Furthermore, the user can transmit the data for initial setting for realizing control by clamping control device 30 from user device 100 to clamping control device 30 by inputting the data for initial setting to user device 100.

Thus, in injection molding system 1000A according to the comparative example, the user individually connects user device 100 to each of injection control device 40 and clamping control device 30 to communicate data between user device 100 and each of injection control device 40 and clamping control device 30. With such a method, in checking currently set data or updating data, the user has to individually connect user device 100 to each of injection control device 40 and clamping control device 30 and work efficiency is poor.

Then, as shown in FIG. 1, injection molding system 1000 according to the embodiment is configured to connect injection control device 40 and clamping control device 30 to each other through a communication cable 55 to communicate data therebetween, without adopting the method of direct connection of clamping control device 30 and user device 100 through communication cable 55A. Injection control device 40 may be configured to communicate data with clamping control device 30 through wireless connection such as Wi-Fi® or Bluetooth®, without being limited to wired connection.

In other words, user device 100 is configured to indirectly communicate data with clamping control device 30 with injection control device 40 being interposed, instead of direct data communication with clamping control device 30. The user thus does not have to directly connect user device 100 to clamping control device 30 through communication cable 55A, and can use user device 100 to easily communicate data with each of injection control device 40 and clamping control device 30 simply by connecting user device 100 to injection control device 40 through communication cable 54.

### Internal Configuration of Injection Molding System

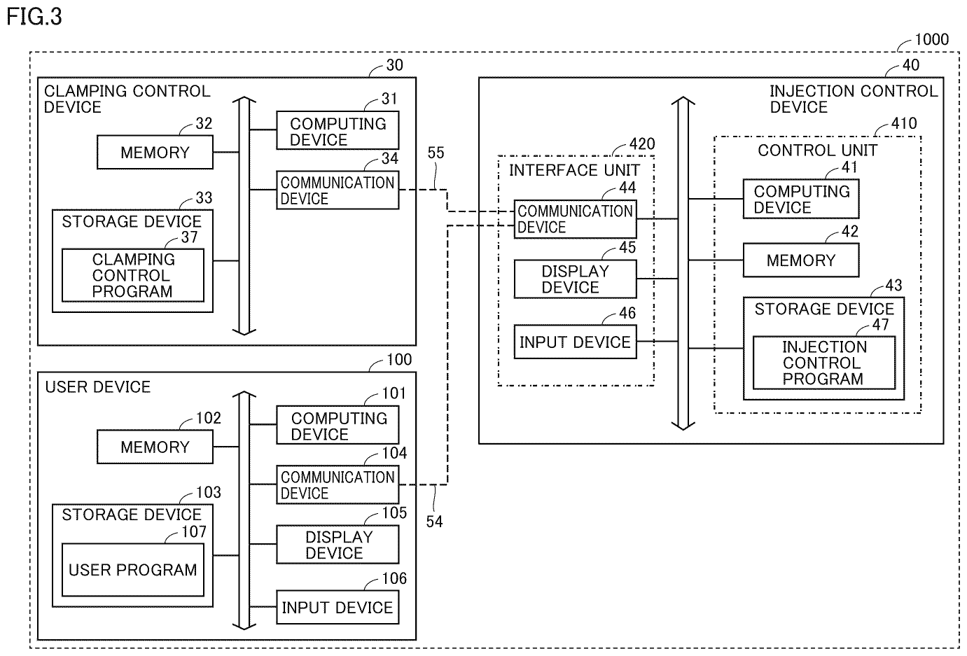

An internal configuration of injection molding system 1000 will be described with reference to FIG. 3. FIG. 3 is a block diagram showing an internal configuration of each of injection control device 40, clamping control device 30, and user device 100 included in injection molding system 1000 according to the embodiment.

As shown in FIG. 3, injection control device 40 includes a computing device 41, a memory 42, a storage device 43, a communication device 44, a display device 45, and an input device 46. Computing device 41, memory 42, and storage device 43 are included in control unit 410. Communication device 44, display device 45, and input device 46 are included in interface unit 420.

Computing device 41 is a computing entity (computer) that performs prescribed processing. Computing device 41 is implemented by a processor such as a central processing unit (CPU), a micro processing unit (MPU), a tensor processing unit (TPU), or a graphics processing unit (GPU). Though the processor which represents an exemplary computing device 41 performs functions to perform prescribed processing by executing a prescribed program, some or all of these functions may be performed by dedicated hardware circuitry such as an application specific integrated circuit (ASIC) or a field programmable gate array (FPGA). The “processor” is not limited to a processor in a narrow sense that performs processing in accordance with a stored program architecture like the CPU, the MPU, the TPU, or the GPU, but may encompass hard-wired circuitry such as the ASIC or the FPGA. Computing device 41 is not limited to a von Neumann computer such as the CPU or the GPU but may be implemented by a non von Neumann computer such as a quantum computer or an optical computer. Computing device 41 may also be read as processing circuitry. Computing device 41 may be implemented by a single chip or a plurality of chips. Furthermore, the processor and relating processing circuitry may be implemented by a plurality of computers connected to one another through wires or wirelessly over a local area network or a wireless network. The processor and the relating processing circuitry may be implemented by a cloud computer that performs remote computation based on input data and outputs a result of computation to another device located at a remote position.

Memory 42 includes a storage area (for example, a working area) where a program code or a work memory is stored in execution of various programs by computing device 41. Examples of memory 42 include a volatile memory such as a dynamic random access memory (DRAM) and a static random access memory (SRAM) or a non-volatile memory such as a read only memory (ROM) and a flash memory. Memory 42 may also be read as processing circuitry.

Various programs to be executed by computing device 41 or various types of data are stored in storage device 43. For example, an injection control program 47 to be executed by computing device 41 is stored in storage device 43. Storage device 43 may be implemented by one or more non-transitory computer readable media or one or more computer readable storage media. Examples of storage device 43 include a hard disk drive (HDD) and a solid state drive (SSD). Storage device 43 may also be read as processing circuitry.

Injection control program 47 defines a processing procedure for control by injection control device 40, of injection of the injection material by injection apparatus 20.

Communication device 44 communicates with each of clamping control device 30 and user device 100 through wired connection using an optical line or the like or wireless connection such as Wi-Fi®. For example, communication device 44 is connected to a communication device 104 of user device 100 through communication cable 54 to communicate data therewith. Communication device 44 is connected to a communication device 34 of clamping control device 30 through communication cable 55 to communicate data therewith. Communication device 44 may also be read as processing circuitry.

Display device 45 includes a display that shows prescribed information under the control by computing device 41. For example, the user can have display device 45 show current data set in injection control device 40. Display device 45 may be read as processing circuitry.

Input device 46 includes a mouse, a keyboard, and the like, and accepts information inputted based on an operation by the user. For example, the user can use input device 46 to input to injection control device 40, data for control by injection control device 40, of injection of the injection material by injection apparatus 20 (for example, data for initial setting or data for update). Input device 46 may be read as processing circuitry. Input device 46 may be a touch panel affixed to display device 45 or a microphone that accepts audio input.

Clamping control device 30 includes a computing device 31, a memory 32, a storage device 33, and communication device 34.

Computing device 31 is a computing entity (computer) that performs prescribed processing. Computing device 31 is implemented by a processor such as a CPU, an MPU, a TPU, or a GPU. Though the processor which represents an exemplary computing device 31 performs functions to perform prescribed processing by executing a prescribed program, some or all of these functions may be performed by dedicated hardware circuitry such as an ASIC or an FPGA. The “processor” is not limited to a processor in a narrow sense that performs processing in accordance with a stored program architecture like the CPU, the MPU, the TPU, or the GPU, but may encompass hard-wired circuitry such as the ASIC or the FPGA. Computing device 31 is not limited to a von Neumann computer such as the CPU or the GPU but may be implemented by a non von Neumann computer such as a quantum computer or an optical computer. Computing device 31 may also be read as processing circuitry. Computing device 31 may be implemented by a single chip or a plurality of chips. Furthermore, the processor and relating processing circuitry may be implemented by a plurality of computers connected to one another through wires or wirelessly over a local area network or a wireless network. The processor and the relating processing circuitry may be implemented by a cloud computer that performs remote computation based on input data and outputs a result of computation to another device located at a remote position.

Memory 32 includes a storage area (for example, a working area) where a program code or a work memory is stored in execution of various programs by computing device 31. Examples of memory 32 include a volatile memory such as a DRAM and an SRAM or a non-volatile memory such as a ROM and a flash memory. Memory 32 may also be read as processing circuitry.

Various programs to be executed by computing device 31 or various types of data are stored in storage device 33. For example, a clamping control program 37 to be executed by computing device 31 is stored in storage device 33. Storage device 33 may be implemented by one or more non-transitory computer readable media or one or more computer readable storage media. Examples of storage device 33 include an HDD and an SSD. Storage device 33 may also be read as processing circuitry.

Clamping control program 37 defines a processing procedure for control of magnet clamps 91 and 92 by clamping control device 30.

Communication device 34 communicates with injection control device 40 through wired connection using an optical line or the like or wireless connection such as Wi-Fi®. For example, communication device 34 is connected to communication device 44 of injection control device 40 through communication cable 55 to communicate data therewith. Communication device 34 may also be read as processing circuitry.

User device 100 includes a computing device 101, a memory 102, a storage device 103, communication device 104, a display device 105, and an input device 106.

Computing device 101 is a computing entity (computer) that performs prescribed processing. Computing device 101 is implemented by a processor such as a CPU, an MPU, a TPU, or a GPU. Though the processor which represents an exemplary computing device 101 performs functions to perform prescribed processing by executing a prescribed program, some or all of these functions may be performed by dedicated hardware circuitry such as an ASIC or an FPGA. The “processor” is not limited to a processor in a narrow sense that performs processing in accordance with a stored program architecture like the CPU, the MPU, the TPU, or the GPU, but may encompass hard-wired circuitry such as the ASIC or the FPGA. Computing device 101 is not limited to a von Neumann computer such as the CPU or the GPU but may be implemented by a non von Neumann computer such as a quantum computer or an optical computer. Computing device 101 may also be read as processing circuitry. Computing device 101 may be implemented by a single chip or a plurality of chips. Furthermore, the processor and relating processing circuitry may be implemented by a plurality of computers connected to one another through wires or wirelessly over a local area network or a wireless network. The processor and the relating processing circuitry may be implemented by a cloud computer that performs remote computation based on input data and outputs a result of computation to another device located at a remote position.

Memory 102 includes a storage area (for example, a working area) where a program code or a work memory is stored in execution of various programs by computing device 101. Examples of memory 102 include a volatile memory such as a DRAM and an SRAM or a non-volatile memory such as a ROM and a flash memory. Memory 102 may also be read as processing circuitry.

Various programs to be executed by computing device 101 or various types of data are stored in storage device 103. For example, a user program 107 to be executed by computing device 101 is stored in storage device 103. Storage device 103 may be implemented by one or more non-transitory computer readable media or one or more computer readable storage media. Examples of storage device 103 include an HDD and an SSD. Storage device 103 may also be read as processing circuitry.

User program 107 defines a processing procedure for communication of data by user device 100 with each of injection control device 40 and clamping control device 30. User program 107 includes an application program for checking by the user, of data currently set in each of injection control device 40 and clamping control device 30 and for update by the user, of data in each of injection control device 40 and clamping control device 30.

Communication device 104 communicates with injection control device 40 through wired connection using an optical line or the like or wireless connection such as Wi-Fi®. For example, communication device 104 is connected to communication device 44 of injection control device 40 through communication cable 54 to communicate data therewith. Communication device 104 may also be read as processing circuitry.

### Exemplary Representation on User Device

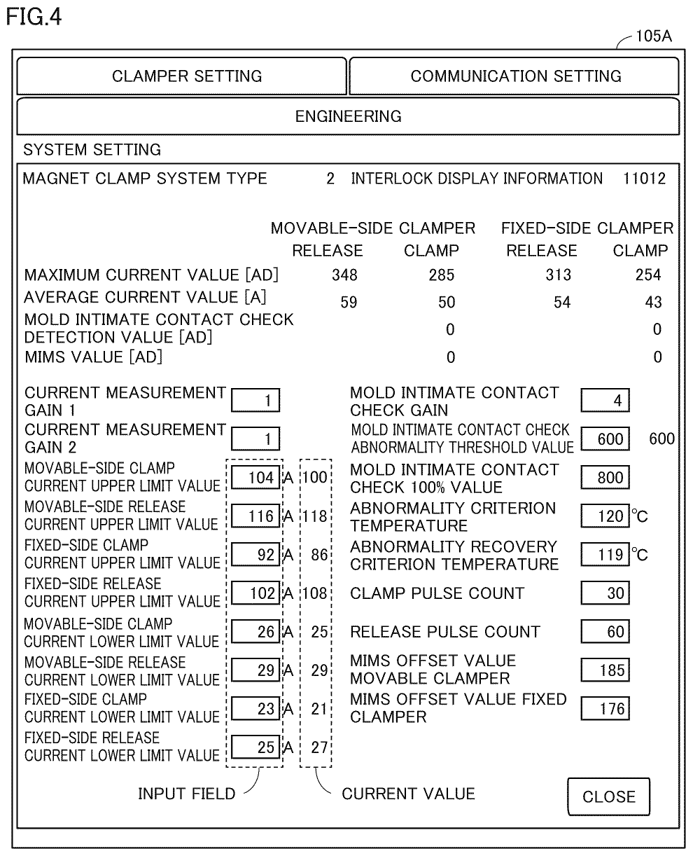

An exemplary screen shown on display device 105 of user device 100 will be described with reference to FIGS. 4 to 6.

FIG. 4 is a diagram showing an exemplary setting screen 105A for setting magnet clamps 91 and 92, which is shown on display device 105 of user device 100 according to the embodiment. As described above, user device 100 can communicate data with clamping control device 30 with injection control device 40 being interposed, and the user can use setting screen 105A shown in FIG. 4 to check current data (for example, a parameter) set in clamping control device 30 or to set data for initial setting (for example, a parameter) for clamping control device 30.

For example, setting screen 105A for setting magnet clamps 91 and 92 includes an input field “current measurement gain 1” and an input field “current measurement gain 2.” When the user inputs a value in the input field “current measurement gain 1” and the input field “current measurement gain 2,” a current value of each of a movable-side clamp current upper limit value, a movable-side release current upper limit value, a fixed-side clamp current upper limit value, a fixed-side release current upper limit value, a movable-side clamp current lower limit value, a movable-side release current lower limit value, a fixed-side clamp current lower limit value, and a fixed-side release current lower limit value is shown.

The movable-side clamp current upper limit value is an upper limit value of the current supplied from clamping control device 30 to magnet clamp 92 for controlling magnet clamp 92 to the clamped state. The movable-side release current upper limit value is an upper limit value of the current supplied from clamping control device 30 to magnet clamp 92 for controlling magnet clamp 92 to the unclamped state.

The fixed-side clamp current upper limit value is an upper limit value of the current supplied from clamping control device 30 to magnet clamp 91 for controlling magnet clamp 91 to the clamped state. The fixed-side release current upper limit value is an upper limit value of the current supplied from clamping control device 30 to magnet clamp 91 for controlling magnet clamp 91 to the unclamped state.

The movable-side clamp current lower limit value is a lower limit value of the current supplied from clamping control device 30 to magnet clamp 92 for controlling magnet clamp 92 to the clamped state. The movable-side release current lower limit value is a lower limit value of the current supplied from clamping control device 30 to magnet clamp 92 for controlling magnet clamp 92 to the unclamped state.

The fixed-side clamp current lower limit value is a lower limit value of the current supplied from clamping control device 30 to magnet clamp 91 for controlling magnet clamp 91 to the clamped state. The fixed-side release current lower limit value is a lower limit value of the current supplied from clamping control device 30 to magnet clamp 91 for controlling magnet clamp 91 to the unclamped state.

Since each of injection molding machine 1 and clamping apparatus 10 has an individual difference, the user obtains the current value of the movable-side clamp current upper limit value or the like by inputting current measurement gain 1 and current measurement gain 2 to apply a current to each of injection molding machine 1 and clamping apparatus 10 while injection molding machine 1 and clamping apparatus 10 are actually connected to each other. The user checks whether or not the obtained current value is within a predetermined setting range, and when the current value is not within the setting range, the user uses input device 106 to change an input value for current measurement gain 1 and current measurement gain 2 such that the current value is within the setting range. The user can also change the setting range by changing an input value for the movable-side clamp current upper limit value or the like.

Setting screen 105A for setting of magnet clamps 91 and 92 includes an input field “mold intimate contact check gain.” When the user inputs a value in the input field “mold intimate contact check gain,” the current value of a mold intimate contact check abnormality threshold value is shown. The user obtains the current value of the mold intimate contact check gain by inputting the mold intimate contact check gain and applying a current to each of injection molding machine 1 and clamping apparatus 10 while injection molding machine 1 and clamping apparatus 10 are actually connected to each other. The user checks whether or not the obtained current value is equal to or smaller than a predetermined threshold value, and when the current value is not equal to or smaller than the threshold value, the user uses input device 106 to change the input value for the mold intimate contact check gain such that the current value is equal to or smaller than the threshold value. The user can also change the threshold value by changing a mold intimate contact check threshold value abnormality threshold value.

In addition, setting screen 105A for setting magnet clamps 91 and 92 shows current values of various types of data on magnet clamps 91 and 92, such as a mold intimate contact check 100% value, an abnormality criterion temperature, and an abnormality recovery criterion temperature, and the user can input setting values for these various types of data.

The current values of various types of data shown in FIG. 4 described above and the setting value inputted in the input field by the user include data to be used in control of magnet clamps 91 and 92 by execution of clamping control program 37 by clamping control device 30 and they are also referred to as “clamping control data.”

The clamping control data may include clamping control program 37 for control of magnet clamps 91 and 92, without being limited to such parameters as current measurement gain 1 and current measurement gain 2 shown in FIG. 4. In other words, the clamping control data may include at least one of a program (for example, clamping control program 37 or an update program for clamping control program 37) for control of magnet clamps 91 and 92 and a parameter to be used for execution of clamping control program 37.

The user can thus use setting screen 105A shown on display device 105 to check the current value of the clamping control data or to input the setting value for the clamping control data.

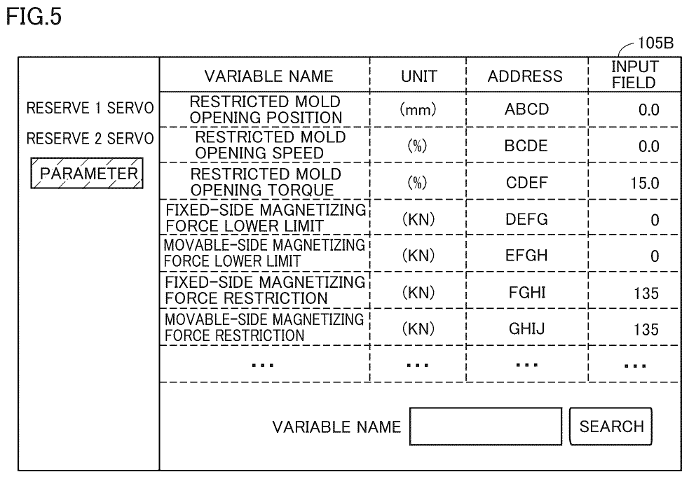

FIG. 5 is a diagram showing an exemplary setting screen 105B for setting injection apparatus 20, which is shown on display device 105 of user device 100 according to the embodiment. As described above, user device 100 can communicate data with injection control device 40 and the user can use setting screen 105B shown in FIG. 5 to check current data (for example, a parameter) set in injection apparatus 20 or to set data for initial setting (for example, a parameter) for injection apparatus 20.

For example, setting screen 105B for injection apparatus 20 includes a variable name, a unit, an address, and an input field for various types of data for injection of the injection material by injection apparatus 20 in accordance with a state of magnet clamps 91 and 92 of clamping control device 30, such as a “restricted mold opening position,” a “restricted mold opening speed,” and “restricted mold opening torque.” The user can input these various types of data in the input fields. In addition, by searching for the variable name, the user can have the current value of the found variable name shown on setting screen 105B, so that the user can check the current values of the various types of data.

The current values of the various types of data shown in FIG. 5 described above and the setting value inputted in the input field by the user include data to be used in control of injection of the injection material by execution of injection control program 47 by injection control device 40, and they are also referred to as “injection control data.”

The injection control data may include injection control program 47 for control of injection of the injection material, without being limited to such a parameter as the restricted mold opening position, the restricted mold opening speed, and the restricted mold opening torque shown in FIG. 5. In other words, the injection control data may include at least one of a program (for example, injection control program 47 or an update program for injection control program 47) for control of injection of the injection material and a parameter to be used for execution of injection control program 47.

The user can thus use setting screen 105B shown on display device 105 to check the current value of the injection control data or to input the setting value for the injection control data.

The user does not have to connect user device 100 to each of injection control device 40 and clamping control device 30 even in the event of occurrence of some kind of abnormality, and the user can have display device 105 of user device 100 show both of setting screen 105A for setting of magnet clamps 91 and 92 in FIG. 4 and setting screen 105B for setting of injection apparatus 20 in FIG. 5, simply by connecting user device 100 to injection control device 40. Since user device 100 can thus be used to check a status of setting of both of magnet clamps 91 and 92 and injection apparatus 20, maintenance can efficiently be performed.

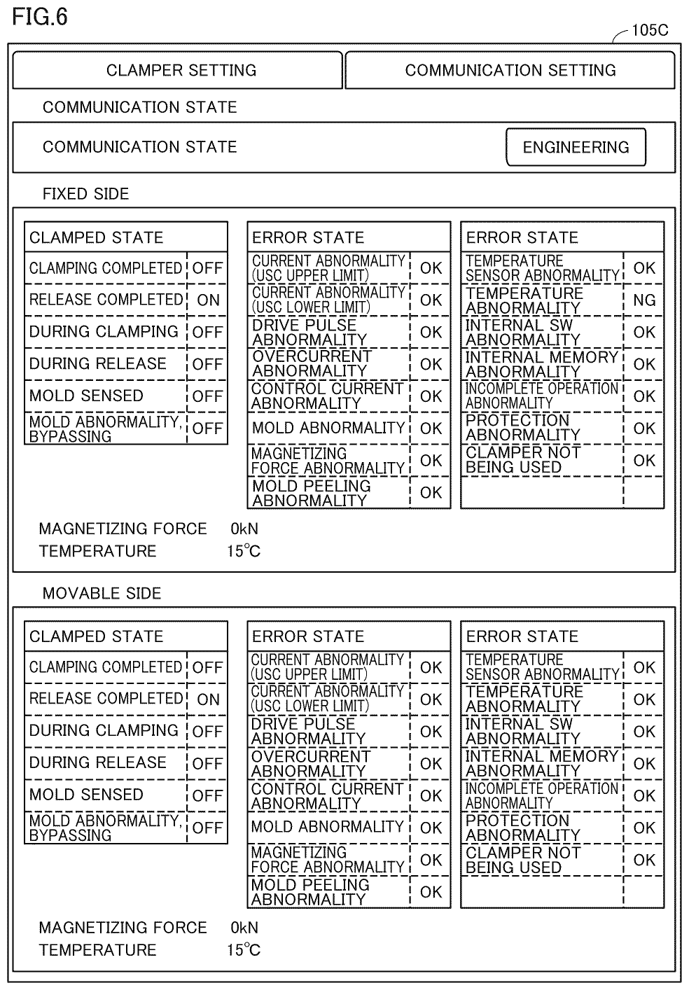

FIG. 6 is a diagram showing an exemplary check screen 105C for checking a state of magnet clamps 91 and 92, which is shown on display device 105 of user device 100 according to the embodiment. The user can use check screen 105C shown in FIG. 6 to check the state of magnet clamps 91 and 92.

For example, check screen 105C for checking the state of magnet clamps 91 and 92 includes check fields where the “clamped state” and an “error state” of magnet clamps 91 and 92 are shown.

In the check fields for checking the clamped state, the state of magnet clamps 91 and 92, such as whether or not clamping by magnet clamps 91 and 92 has been completed and whether or not release by magnet clamps 91 and 92 has been completed, is shown. In the example in FIG. 6, “ON” is shown in the check field where whether or not release by magnet clamps 91 and 92 has been completed is shown, and “OFF” is shown in other check fields. In this case, the user can use check screen 105C to confirm completion of release by magnet clamps 91 and 92.

In the check fields for checking the error state, the error state of magnet clamps 91 and 92 such as current abnormality and temperature abnormality is shown. In the example in FIG. 6, “NG” is shown in the check field for temperature abnormality of magnet clamp 91 on a fixed side and “OK” is shown in other check fields. In this case, the user can use check screen 105C to confirm occurrence of abnormality of the temperature of magnet clamp 91 detected by temperature sensor 94.

Data indicating whether or not magnet clamps 91 and 92 are in the clamped state shown in FIG. 6 described above and data indicating the error state of magnet clamps 91 and 92 are data indicating the state of magnet clamps 91 and 92, and they are also referred to as “state data.”

The user can thus use check screen 105C shown on display device 105 to check information indicating the clamped state of magnet clamps 91 and 92 and information on an error of the magnet clamp. Furthermore, the user can use check screen 105C shown on display device 105 to check in which of magnet clamp 91 and magnet clamp 92 the error has occurred and a type of the error that has occurred.

In injection molding system 1000A according to the comparative example shown in FIG. 2, injection control device 40 and clamping control device 30 are not connected to each other to communicate data therebetween. Therefore, injection control device 40 has been unable to specify the type of the error that has occurred in clamping control device 30. In contrast, in injection molding system 1000 according to the embodiment, injection control device 40 and clamping control device 30 are connected to each other to communicate data therebetween. Therefore, injection control device 40 can specify the type of the error that has occurred in clamping control device 30 based on the state data obtained from clamping control device 30.

### Exemplary Shared Address

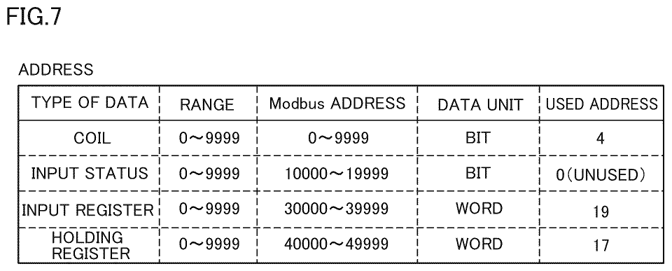

Injection control device 40 is configured to communicate data with clamping control device 30 with the use of an address shared with clamping control device 30. An address shared between injection control device 40 and clamping control device 30 according to the embodiment will be described with reference to FIGS. 7 to 10.

FIG. 7 is a diagram showing an exemplary range of an address shared between injection control device 40 and clamping control device 30 according to the embodiment. As shown in FIG. 7, data is communicated between injection control device 40 and clamping control device 30 in accordance with a Modbus® communication protocol. Types of data in data communication include a coil, an input status, an input register, and a holding register.

The coil refers to a data area where only reading can be performed in a unit of one bit, and addresses within a range from 0 to 9999 are allocated to the coil. The input status refers to a data area where reading and writing can be performed in a unit of one bit, and addresses within a range from 10000 to 19999 are allocated to the input status. The input register refers to a data area where only reading can be performed in a unit of one word, and addresses within a range from 30000 to 39999 are allocated to the input register. The holding register refers to a data area where reading and writing can be performed in a unit of one word, and addresses within a range from 40000 to 49999 are allocated to the holding register.

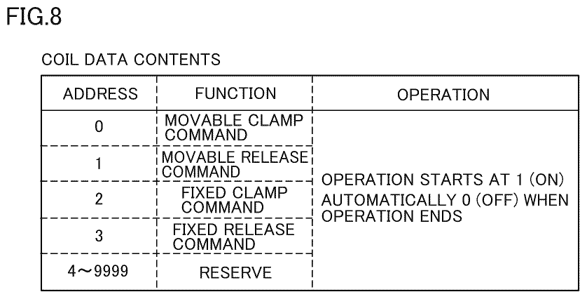

FIG. 8 is a diagram showing contents of coil data shared between injection control device 40 and clamping control device 30 according to the embodiment. As shown in FIG. 8, data on a control command for magnet clamps 91 and 92 is stored at addresses 0 to 3 of the coil data. Addresses 4 to 9999 of the coil data are provided as reserve.

Data on control of magnet clamp 92 to the clamped state is stored at the address 0 of the coil data. For example, in an example where clamping control device 30 controls magnet clamp 92 to the clamped state, data “1” is stored at the address 0, and in an example where clamping control device 30 does not control magnet clamp 92 to the clamped state, data “0” is stored at the address 0.

Data on control of magnet clamp 92 to the unclamped state is stored at the address 1 of the coil data. For example, in an example where clamping control device 30 controls magnet clamp 92 to the unclamped state, data “1” is stored at the address 1, and in an example where clamping control device 30 does not control magnet clamp 92 to the unclamped state, data “0” is stored at the address 1.

Data on control of magnet clamp 91 to the clamped state is stored at the address 2 of the coil data. For example, in an example where clamping control device 30 controls magnet clamp 91 to the clamped state, data “1” is stored at the address 2, and in an example where clamping control device 30 does not control magnet clamp 91 to the clamped state, data “0” is stored at the address 2.

Data on control of magnet clamp 91 to the unclamped state is stored at the address 3 of the coil data. For example, in an example where clamping control device 30 controls magnet clamp 91 to the unclamped state, data “1” is stored at the address 3, and in an example where clamping control device 30 does not control magnet clamp 91 to the unclamped state, data “0” is stored at the address 3.

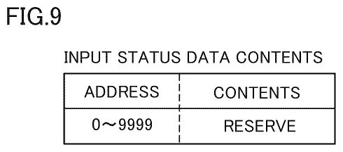

FIG. 9 is a diagram showing contents of input status data shared between injection control device 40 and clamping control device 30 according to the embodiment. As shown in FIG. 9, addresses 0 to 9999 of the input status data are provided as reserve.

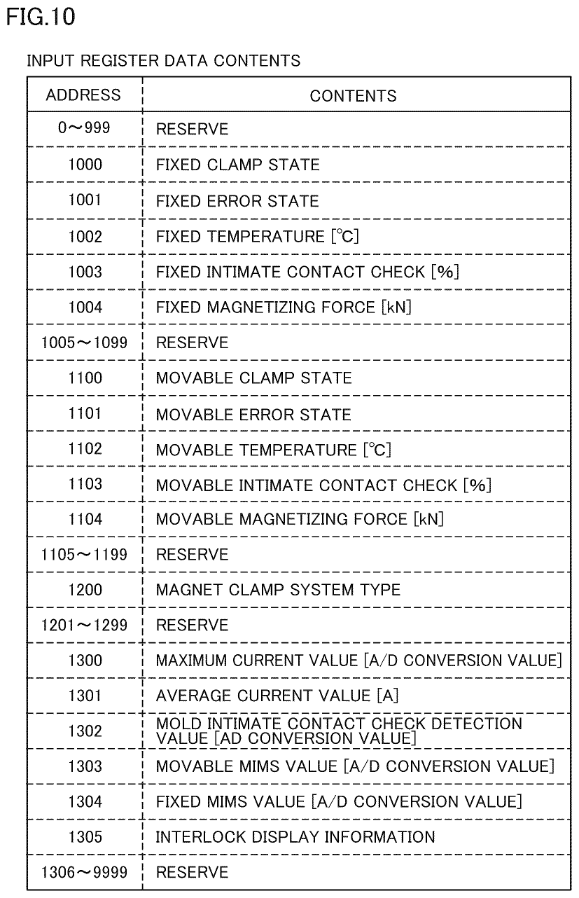

FIG. 10 is a diagram showing contents of input register data shared between injection control device 40 and clamping control device 30 according to the embodiment. As shown in FIG. 10, the state data indicating the state of magnet clamps 91 and 92 such as data indicating whether or not magnet clamps 91 and 92 are in the clamped state and data indicating the error state of magnet clamps 91 and 92 is stored in the input register data.

For example, data indicating the clamped state of magnet clamp 91 is stored at an address 1000 of the input register data. Data indicating the error state of magnet clamp 91 is stored at an address 1001 of the input register data. Data indicating a temperature (for example, a measurement value from temperature sensor 94) of magnet clamp 91 is stored at an address 1002 of the input register data. Data indicating a result of checking of a degree of intimate contact of magnet clamp 91 is stored at an address 1003 of the input register data. Data indicating magnetizing force (for example, a measurement value from magnetic field sensor 95) of magnet clamp 91 is stored at an address 1004 of the input register data.

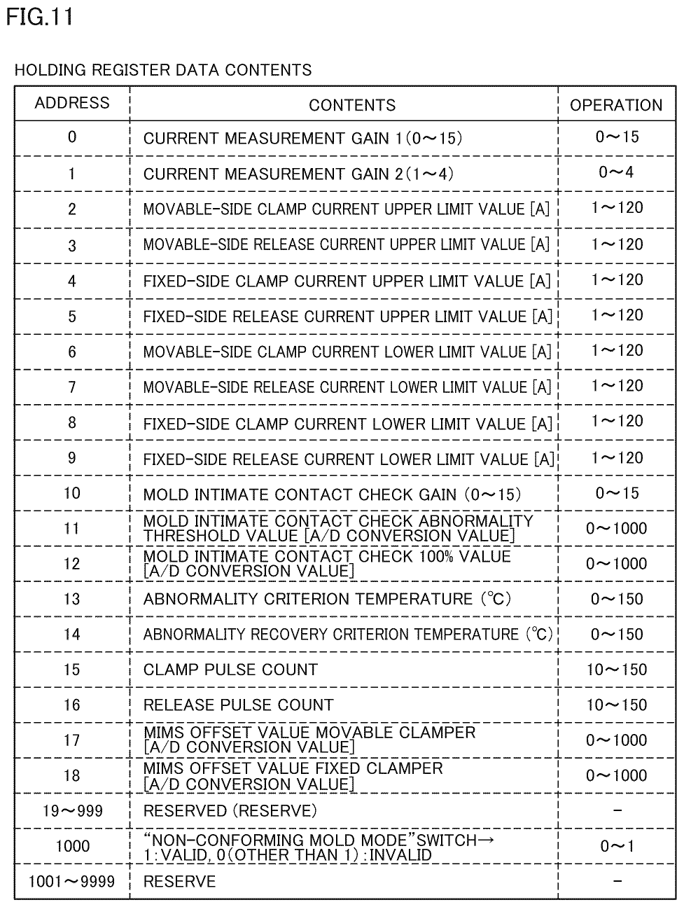

FIG. 11 is a diagram showing contents of holding register data shared between injection control device 40 and clamping control device 30 according to the embodiment. As shown in FIG. 11, clamping control data on magnet clamps 91 and 92 such as current data set in clamping control device 30 and data for initial setting for clamping control device 30 as shown in FIG. 4 is stored in the holding register data.

For example, data indicating current measurement gain 1 is stored at an address 0 of the holding register data. Data indicating current measurement gain 2 is stored at an address 1 of the holding register data. Data indicating the movable-side clamp current upper limit value is stored at an address 2 of the holding register data. Data indicating the movable-side release current upper limit value is stored at an address 3 of the holding register data. Data indicating the fixed-side clamp current upper limit value is stored at an address 4 of the holding register data. Data indicating the fixed-side release current upper limit value is stored at an address 5 of the holding register data. Data indicating the movable-side clamp current lower limit value is stored at an address 6 of the holding register data. Data indicating the movable-side release current lower limit value is stored at an address 7 of the holding register data. Data indicating the fixed-side clamp current lower limit value is stored at an address 8 of the holding register data. Data indicating the fixed-side release current lower limit value is stored at an address 9 of the holding register data.

In addition, the clamping control data on magnet clamps 91 and 92 such as the mold intimate contact check 100% value, the abnormality criterion temperature, and the abnormality recovery criterion temperature is stored at addresses of the holding register data.

### Exemplary Processing Performed by Injection Molding Machine

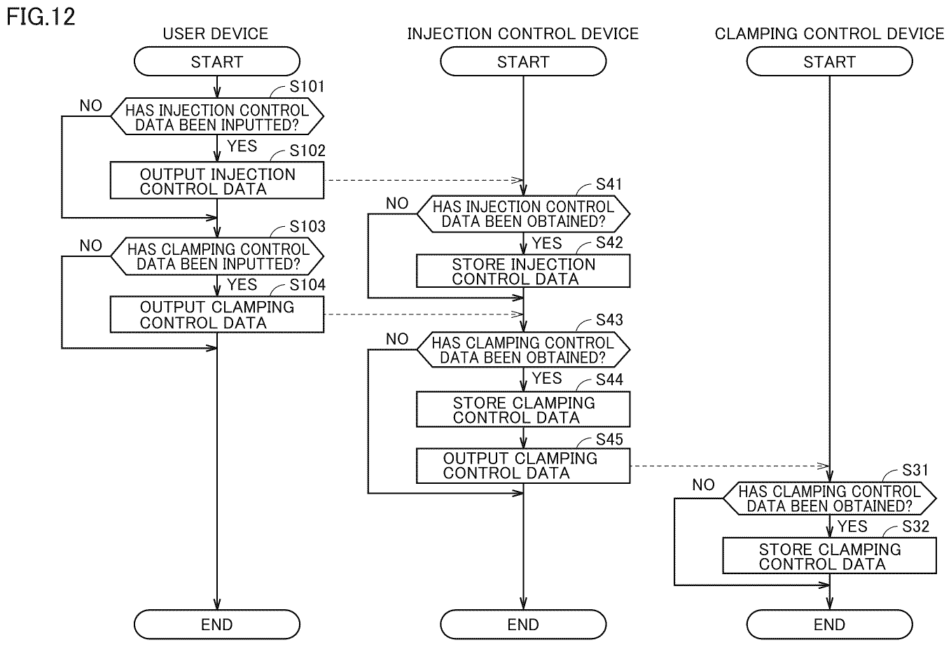

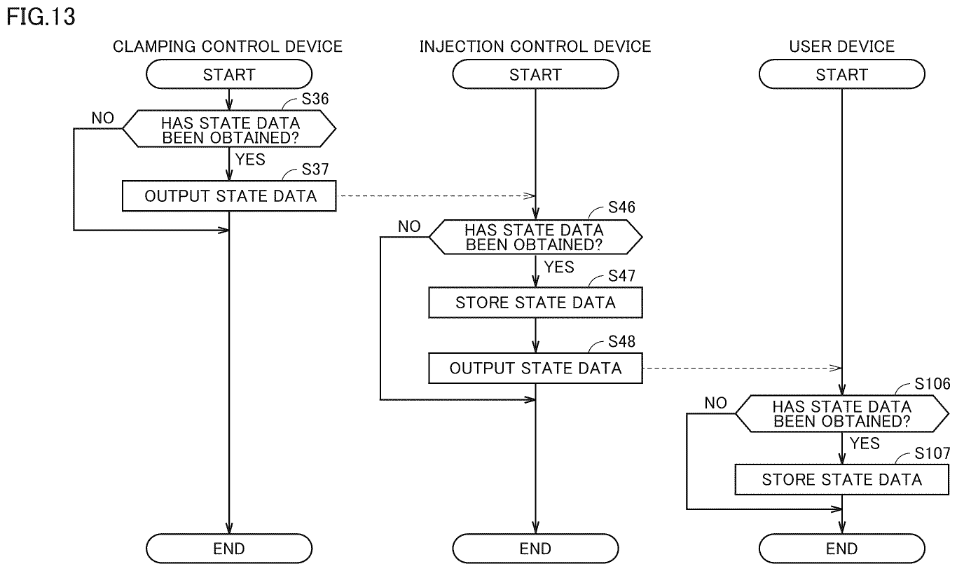

Exemplary processing performed by injection molding machine 1 will be described with reference to FIGS. 12 and 13. A process step in user device 100 is performed by execution of user program 107 by computing device 101. A process step in injection control device 40 is performed by execution of injection control program 47 by computing device 41. A process step in clamping control device 30 is performed by execution of clamping control program 37 by computing device 31.

FIG. 12 is a flowchart showing exemplary processing relating to the injection control data and the clamping control data, which is performed by injection molding machine 1 according to the embodiment. As shown in FIG. 12, user device 100 determines whether or not the user has used input device 106 to input the injection control data (S101). As described above, the injection control data includes at least one of the program (for example, injection control program 47 or the update program for injection control program 47) for control of injection of the injection material and the parameter to be used for execution of injection control program 47.

When user device 100 has received input of the injection control data (YES in S101), it outputs the obtained injection control data to injection control device 40 (S102) and makes transition to processing in S103. When user device 100 has not received input of the injection control data (NO in S101), on the other hand, it skips processing in S102.

In response, injection control device 40 determines whether or not it has obtained the injection control data from user device 100 (S41). When injection control device 40 has obtained the injection control data (YES in S41), it has the obtained injection control data stored in storage device 43 (S42). Injection control device 40 can thus use the injection control data stored in storage device 43 to control injection of the injection material. For example, injection control device 40 can use the update program included in the injection control data to update injection control program 47 to a latest version. Alternatively, injection control device 40 can use the parameter included in the injection control data to control injection of the injection material.

When injection control device 40 has not obtained the injection control data (NO in S41), on the other hand, it skips processing in S42.

User device 100 determines whether or not the user has used input device 106 to input the clamping control data (S103). As described above, the clamping control data includes at least one of the program (for example, clamping control program 37 or the update program for clamping control program 37) for control of magnet clamps 91 and 92 and the parameter to be used for execution of clamping control program 37.

When user device 100 has received input of the clamping control data (YES in S103), it outputs the obtained clamping control data to injection control device 40 (S104) and quits the process relating to the present flow. When user device 100 has not received input of the clamping control data (NO in S103), on the other hand, it skips processing in S104 and quits the process relating to the present flow.

In response, injection control device 40 determines whether or not it has obtained the clamping control data from user device 100 (S43). When injection control device 40 has obtained the clamping control data (YES in S43), it has the obtained clamping control data stored in storage device 43 (S44). Furthermore, injection control device 40 outputs the clamping control data to clamping control device 30 (S45) and quits the process relating to the present flow. When injection control device 40 has not obtained the clamping control data (NO in S43), on the other hand, it skips processing in S44 and S45 and quits the process relating to the present flow.

In response, clamping control device 30 determines whether or not it has obtained the clamping control data from injection control device 40 (S31). When clamping control device 30 has obtained the clamping control data (YES in S31), it has the obtained clamping control data stored in storage device 33 (S32) and quits the process relating to the present flow. Clamping control device 30 can thus use the clamping control data stored in storage device 33 to control magnet clamps 91 and 92. For example, clamping control device 30 can use the update program included in the clamping control data to update clamping control program 37 to a latest version. Alternatively, clamping control device 30 can use the parameter included in the clamping control data to control magnet clamps 91 and 92.

When clamping control device 30 has not obtained the clamping control data (NO in S31), on the other hand, it skips processing in S32 and quits the process relating to the present flow.

As set forth above, by using user device 100 to input the injection control data, the user can have the injection control data stored in injection control device 40, and can use the update program included in the injection control data to have injection control device 40 update injection control program 47 to the latest version or can use the parameter included in the injection control data to have injection control device 40 control injection of the injection material.

By using user device 100 to input the clamping control data, the user can transfer the clamping control data to clamping control device 30 through injection control device 40, and can use the clamping control data to have clamping control device 30 control magnet clamps 91 and 92.

The user can thus easily communicate data with each of injection control device 40 and clamping control device 30 without individually connecting user device 100 to each of injection control device 40 and clamping control device 30.

FIG. 13 is a flowchart showing exemplary processing relating to the state data, which is performed by injection molding machine 1 according to the embodiment. As shown in FIG. 13, clamping control device 30 determines whether or not it has obtained the state data from temperature sensor 94, magnetic field sensor 95, or the like (S36). As described above, the state data includes at least one of the information indicating whether or not magnet clamps 91 and 92 are in the clamped state and the information on the error of magnet clamps 91 and 92.

When clamping control device 30 has obtained the state data (YES in S36), it outputs the obtained state data to injection control device 40 (S37) and quits the process relating to the present flow. When clamping control device 30 has not obtained the state data (NO in S36), on the other hand, it skips processing in S37 and quits the process relating to the present flow.

In response, injection control device 40 determines whether or not it has obtained the state data from clamping control device 30 (S46). When injection control device 40 has obtained the state data (YES in S46), it has the obtained state data stored in storage device 43 (S47). Injection control device 40 can thus use the state data stored in storage device 43 to recognize whether or not magnet clamps 91 and 92 are in the clamped state and the error state of magnet clamps 91 and 92 and can control injection of the injection material in accordance with the state of magnet clamps 91 and 92.

Furthermore, injection control device 40 outputs the state data to user device 100 (S48) and quits the process relating to the present flow. When injection control device 40 has not obtained the state data (NO in S46), on the other hand, it skips processing in S47 and S48 and quits the process relating to the present flow.

In response, user device 100 determines whether or not it has obtained the state data from injection control device 40 (S106). When user device 100 has obtained the state data (YES in S106), it has the obtained state data stored in storage device 103 (S107). When user device 100 has not obtained the state data (NO in S106), on the other hand, it skips processing in S107 and quits the process relating to the present flow.

The user can thus use user device 100 to view the state data obtained from clamping control device 30 through injection control device 40, without individually connecting user device 100 to each of injection control device 40 and clamping control device 30.

### Additional Aspects

The embodiment described above is understood by a person skilled in the art as specific examples of aspects below.
(Clause 1) An injection molding machine (1) according to the present disclosure manufactures a molded article by injecting an injection material into a mold (17, 18). The injection molding machine (1) includes an injection apparatus (20) that injects the injection material into the mold (17, 18) and a clamping apparatus (10) that clamps the mold (17, 18). The injection apparatus (20) includes an injection control device (40) that controls injection of the injection material. The clamping apparatus (10) includes a magnet clamp (91, 92) to which the mold (17, 18) is removably attached and a clamping control device (30) that controls the magnet clamp (91, 92). The injection control device (40) is connected to the clamping control device (30) to communicate data therewith.
(Clause 2) In the injection molding machine (1) according to Clause 1, the injection control device (40) is connected to a user device (100) to communicate data therewith. The injection control device (40) is configured to obtain injection control data on injection of the injection material from the user device (100) (S41) and store the injection control data (S42).
(Clause 3) In the injection molding machine (1) according to Clause 1 or 2, the injection control device (40) is configured to obtain clamping control data on the magnet clamp (91, 92) from the user device (100) (S43) and output the clamping control data to the clamping control device (30) (S45). The clamping control device (30) is configured to store the clamping control data (S32).
(Clause 4) In the injection molding machine (1) according to Clause 2 or 3, the injection control data and the clamping control data are inputted by a user using the user device (100).
(Clause 5) In the injection molding machine (1) according to any of Clauses 2 to 4, the injection control data includes at least one of a program for control of injection of the injection material and a parameter to be used for execution of the program.
(Clause 6) In the injection molding machine (1) according to any of Clauses 3 to 5, the clamping control data includes at least one of a program for control of the magnet clamp (91, 92) and a parameter to be used for execution of the program.
(Clause 7) In the injection molding machine (1) according to any of Clauses 1 to 6, the injection control device (40) is configured to obtain state data indicating a state of the magnet clamp (91, 92) from the clamping control device (30) (S46) and output the state data to a user device (100) (S48).
(Clause 8) In the injection molding machine (1) according to Clause 7, the state data includes at least one of information indicating a clamped state or an unclamped state and information on an error of the magnet clamp (91, 92), the clamped state being a state in which the mold (17, 18) is attached to the magnet clamp (91, 92), the unclamped state being a state in which the mold (17, 18) has been removed from the magnet clamp (91, 92).
(Clause 9) In the injection molding machine (1) according to any of Clauses 1 to 8, the injection control device (40) is configured to communicate data with the clamping control device (30) by using an address shared with the clamping control device (30).
(Clause 10) An injection apparatus (20) according to the present disclosure injects an injection material into a mold (17, 18) to be clamped by a clamping apparatus (10). The injection apparatus (20) includes an injection control device (40) that controls injection of the injection material. The clamping apparatus (10) includes a magnet clamp (91, 92) to which the mold (17, 18) is removably attached and a clamping control device (30) that controls the magnet clamp (91, 92). The injection control device (40) is connected to the clamping control device (30) to communicate data therewith.
(Clause 11) In the injection apparatus (20) according to Clause 10, the injection control device (40) is connected to a user device (100) to communicate data therewith. The injection control device (40) is configured to obtain injection control data on injection of the injection material from the user device (100) and store the injection control data.
(Clause 12) In the injection apparatus (20) according to Clause 10 or 11, the injection control device (40) is configured to obtain clamping control data on the magnet clamp (91, 92) from the user device (100) and output the clamping control data to the clamping control device (30).
(Clause 13) In the injection apparatus (20) according to Clause 11 or 12, the injection control data and the clamping control data are inputted by a user using the user device (100).
(Clause 14) In the injection apparatus (20) according to any of Clauses 11 to 13, the injection control data includes at least one of a program for control of injection of the injection material and a parameter to be used for execution of the program.
(Clause 15) In the injection apparatus (20) according to any of Clauses 12 to 14, the clamping control data includes at least one of a program for control of the magnet clamp (91, 92) and a parameter to be used for execution of the program.
(Clause 16) In the injection apparatus (20) according to any of Clauses 10 to 15, the injection control device (40) is configured to obtain state data indicating a state of the magnet clamp (91, 92) from the clamping control device (30) and output the state data to a user device (100).
(Clause 17) In the injection apparatus (20) according to Clause 16, the state data includes at least one of information indicating a clamped state or an unclamped state and information on an error of the magnet clamp (91, 92), the clamped state being a state in which the mold (17, 18) is attached to the magnet clamp (91, 92), the unclamped state being a state in which the mold (17, 18) has been removed from the magnet clamp (91, 92).
(Clause 18) In the injection apparatus (20) according to any of Clauses 10 to 17, the injection control device (40) is configured to communicate data with the clamping control device (30) by using an address shared with the clamping control device (30).
(Clause 19) A clamping apparatus (10) according to the present disclosure clamps a mold (17, 18) for manufacturing a molded article with an injection material injected from an injection apparatus (20). The clamping apparatus (10) includes a magnet clamp (91, 92) to which the mold (17, 18) is removably attached and a clamping control device (30) that controls the magnet clamp (91, 92). The clamping control device (30) is connected to an injection control device (40) to communicate data therewith, the injection control device controlling injection of the injection material by the injection apparatus (20).
(Clause 20) In the clamping apparatus (10) according to Clause 19, clamping control data on the magnet clamp (91, 92) inputted by a user using a user device (100) is obtained from the injection control device (40) and the clamping control data is stored.
(Clause 21) In the clamping apparatus (10) according to Clause 20, the clamping control data includes at least one of a program for control of the magnet clamp (91, 92) and a parameter to be used for execution of the program.
(Clause 22) In the clamping apparatus (10) according to any of Clauses 19 to 21, the clamping control device (30) is configured to output state data indicating a state of the magnet clamp (91, 92) to the injection control device (40).
(Clause 23) In the clamping apparatus (10) according to Clause 22, the state data includes at least one of information indicating a clamped state or an unclamped state and information on an error of the magnet clamp (91, 92), the clamped state being a state in which the mold (17, 18) is attached to the magnet clamp (91, 92), the unclamped state being a state in which the mold (17, 18) has been removed from the magnet clamp (91, 92).
(Clause 24) In the clamping apparatus (10) according to any of Clauses 19 to 23, the clamping control device (30) is configured to communicate data with the injection control device (40) by using an address shared with the injection control device (40).
(Clause 25) A method of data processing according to the present disclosure is a method of data processing by an injection control device (40) of an injection apparatus (20) that injects an injection material into a mold (17, 18) to be clamped by a clamping apparatus (10). The method of data processing includes obtaining injection control data on injection of the injection material from a user device (100) (S41), storing the injection control data (S42), obtaining clamping control data on a magnet clamp (91, 92) of the clamping apparatus (10) from the user device (100) (S43), and outputting the clamping control data to a clamping control device (30) that controls the magnet clamp (91, 92) (S45).
(Clause 26) In the method of data processing according to Clause 25, the injection control data and the clamping control data are inputted by a user using the user device (100).
(Clause 27) In the method of data processing according to Clause 25 or 26, the injection control data includes at least one of a program for control of injection of the injection material and a parameter to be used for execution of the program.
(Clause 28) In the method of data processing according to any of Clauses 25 to 27, the clamping control data includes at least one of a program for control of the magnet clamp (91, 92) and a parameter to be used for execution of the program.
(Clause 29) The method of data processing according to any of Clauses 25 to 28 includes obtaining state data indicating a state of the magnet clamp (91, 92) from the clamping control device (30) (S46) and outputting the state data to the user device (100) (S48).
(Clause 30) In the method of data processing according to Clause 29, the state data includes at least one of information indicating a clamped state or an unclamped state and information on an error of the magnet clamp (91, 92), the clamped state being a state in which the mold (17, 18) is attached to the magnet clamp (91, 92), the unclamped state being a state in which the mold (17, 18) has been removed from the magnet clamp (91, 92).

Though an embodiment of the present invention has been described, it should be understood that the embodiment disclosed herein is illustrative and non-restrictive in every respect. The scope of the present invention is defined by the terms of the claims and is intended to include any modifications within the scope and meaning equivalent to the terms of the claims.

What is claimed is:

1. An injection molding machine that manufactures a molded article by injecting an injection material into a mold, the injection molding machine comprising:
an injection apparatus that injects the injection material into the mold; and
a clamping apparatus that clamps the mold, wherein
the injection apparatus includes an injection control device that controls injection of the injection material,
the clamping apparatus includes
a magnet clamp to which the mold is removably attached, and
a clamping control device that controls the magnet clamp, and
the injection control device is connected to the clamping control device to communicate data with the clamping control device.

2. The injection molding machine according to claim 1, wherein
the injection control device is connected to a user device to communicate data with the user device, and
the injection control device is configured to
obtain injection control data on injection of the injection material from the user device, and
store the injection control data.

3. The injection molding machine according to claim 2, wherein
the injection control device is configured to
obtain clamping control data on the magnet clamp from the user device, and
output the clamping control data to the clamping control device, and
the clamping control device is configured to store the clamping control data.

4. The injection molding machine according to claim 3, wherein
the injection control data and the clamping control data are inputted by a user using the user device.

5. The injection molding machine according to claim 2, wherein
the injection control data includes at least one of a program for control of injection of the injection material and a parameter to be used for execution of the program.

6. The injection molding machine according to claim 3, wherein
the clamping control data includes at least one of a program for control of the magnet clamp and a parameter to be used for execution of the program.

7. The injection molding machine according to claim 1, wherein
the injection control device is configured to
obtain state data indicating a state of the magnet clamp from the clamping control device, and
output the state data to a user device.

8. The injection molding machine according to claim 7, wherein
the state data includes at least one of information indicating a clamped state or an unclamped state and information on an error of the magnet clamp, the clamped state being a state in which the mold is attached to the magnet clamp, the unclamped state being a state in which the mold has been removed from the magnet clamp.

9. The injection molding machine according to claim 1, wherein
the injection control device is configured to communicate data with the clamping control device by using an address shared with the clamping control device.

10. An injection apparatus that injects an injection material into a mold to be clamped by a clamping apparatus, the injection apparatus comprising:
an injection control device that controls injection of the injection material, wherein
the clamping apparatus includes
a magnet clamp to which the mold is removably attached, and
a clamping control device that controls the magnet clamp, and
the injection control device is connected to the clamping control device to communicate data with the clamping control device.

11. The injection apparatus according to claim 10, wherein
the injection control device is connected to a user device to communicate data with the user device, and
the injection control device is configured to
obtain injection control data on injection of the injection material from the user device, and
store the injection control data.

12. The injection apparatus according to claim 11, wherein
the injection control device is configured to
obtain clamping control data on the magnet clamp from the user device, and
output the clamping control data to the clamping control device.

13. The injection apparatus according to claim 12, wherein
the injection control data and the clamping control data are inputted by a user using the user device.

14. The injection apparatus according to claim 11, wherein
the injection control data includes at least one of a program for control of injection of the injection material and a parameter to be used for execution of the program.

15. The injection apparatus according to claim 12, wherein
the clamping control data includes at least one of a program for control of the magnet clamp and a parameter to be used for execution of the program.

16. The injection apparatus according to claim 10, wherein
the injection control device is configured to
obtain state data indicating a state of the magnet clamp from the clamping control device, and
output the state data to a user device.

17. The injection apparatus according to claim 16, wherein
the state data includes at least one of information indicating a clamped state or an unclamped state and information on an error of the magnet clamp, the clamped state being a state in which the mold is attached to the magnet clamp, the unclamped state being a state in which the mold has been removed from the magnet clamp.

18. The injection apparatus according to claim 10, wherein
the injection control device is configured to communicate data with the clamping control device by using an address shared with the clamping control device.

19. A clamping apparatus that clamps a mold for manufacturing a molded article with an injection material injected from an injection apparatus, the clamping apparatus comprising:
a magnet clamp to which the mold is removably attached; and
a clamping control device that controls the magnet clamp, wherein
the clamping control device is connected to an injection control device to communicate data with the injection control device, the injection control device controlling injection of the injection material by the injection apparatus.

20. The clamping apparatus according to claim 19, wherein
the clamping control device
obtains from the injection control device, clamping control data on the magnet clamp inputted by a user using a user device, and
stores the clamping control data.

21. The clamping apparatus according to claim 20, wherein
the clamping control data includes at least one of a program for control of the magnet clamp and a parameter to be used for execution of the program.

22. The clamping apparatus according to claim 19, wherein
the clamping control device is configured to output state data indicating a state of the magnet clamp to the injection control device.

23. The clamping apparatus according to claim 22, wherein
the state data includes at least one of information indicating a clamped state or an unclamped state and information on an error of the magnet clamp, the clamped state being a state in which the mold is attached to the magnet clamp, the unclamped state being a state in which the mold has been removed from the magnet clamp.

24. The clamping apparatus according to claim 19, wherein
the clamping control device is configured to communicate data with the injection control device by using an address shared with the injection control device.

25. A method of data processing by an injection control device of an injection apparatus that injects an injection material into a mold to be clamped by a clamping apparatus, the method comprising:
obtaining injection control data on injection of the injection material from a user device;
storing the injection control data;
obtaining clamping control data on a magnet clamp of the clamping apparatus from the user device; and
outputting the clamping control data to a clamping control device that controls the magnet clamp.

26. The method of data processing according to claim 25, wherein
the injection control data and the clamping control data are inputted by a user using the user device.

27. The method of data processing according to claim 25, wherein
the injection control data includes at least one of a program for control of injection of the injection material and a parameter to be used for execution of the program.

28. The method of data processing according to claim 25, wherein
the clamping control data includes at least one of a program for control of the magnet clamp and a parameter to be used for execution of the program.

29. The method of data processing according to claim 25, comprising:
obtaining state data indicating a state of the magnet clamp from the clamping control device; and
outputting the state data to the user device.

30. The method of data processing according to claim 29, wherein
the state data includes at least one of information indicating a clamped state or an unclamped state and information on an error of the magnet clamp, the clamped state being a state in which the mold is attached to the magnet clamp, the unclamped state being a state in which the mold has been removed from the magnet clamp.
